(19) United States
(12) Patent Application Publication
(10) Pub. No.: US 2009/0107257 A1
(43) Pub. Date: Apr. 30, 2009

(54) (DISC) MAGNETIC TORQUE SENSING WITH SEGMENTS

(76) Inventor: Lutz Axel May, Gelting (DE)

Correspondence Address: BLANK ROME, 600 New Hampshire Avenue, NW, Watergate 600, 11th Floor, Washington, DC, 20037-2485, US

(21) Appl. No.: 10/480,597

(22) PCT Filed: Jun. 7, 2002
(86) PCT No.: PCT/EP02/06300

§ 371 Date: Jan. 18, 2007

(30) Foreign Application Priority Data
Jun. 12, 2001 (GB) 0114279.3

(51) Int. Cl. G01L 3/10

(52) U.S. Cl. 73/862.08

(57) ABSTRACT

A torque transducer system comprises a disc through which torque is transmitted in a radial direction and which has a magnetised annular region which emanates a torque-dependent magnetic field. A non-contacting magnetic field sensor detects the emanated field. The annular region comprises segments by means of which a pulsed magnetic field is emanated as the disc rotates. The segments may be magnetically unipolar and spatially separated or of alternate polarity. They may be integral with the disc of or material applied to the disc that is magnetised or that segments an underlying magnetisation in the disc. The preferred direction of magnetisation is radial and the effect of the orientation of a sensor with respect to the radial field is discussed. One sensor arrangement comprises a pair of sensors oriented at an angle to one another with reference to the radial field. The teachings of the invention can be applied to the segmentation of an integral transducer region of a torque-transmitting shaft, the region having an annulus of axially-directed remanent magnetization.

### FIELD OF THE INVENTION

This invention relates to a magnetic torque-sensing element comprising a disc through which torque is radially transmissible or comprising a member for transmitting torque about a torque axis in the direction of the axis. The invention also relates to a transducer assembly including such a torque-sensing element.

The invention is concerned with a magnetic-based torque sensor for a disc or other structure which is mounted for rotation about an axis and which transmits torque in a generally radial direction. Unless otherwise required by the context, the term “disc” will be used to encompass all such structures. A disc mounted for rotation about an axis includes discs that continually rotate about the axis, discs that rotate to a limited extent and discs which are restrained from significant rotation but in which torque may nonetheless be established.

The invention is also concerned with a magnetic-based torque sensor for a shaft or other member through which torque is transmitted and which is provided with a magnetic transducer element in which the magnetisation extends in the axial direction in an annulus about the torque axis.

### BACKGROUND TO THE INVENTION

Various proposals have been made to measure torque transmitted through a disc in a radial direction by means of a magnetically-based transducer comprising a magnetic transducer element formed in or carried by the disc to respond to torque therein and emanate a magnetic field or a component of a field which is dependent on torque. The emanated field is sensed by a non-contacting sensor arrangement, particularly for discs which rotate to at least a limited extent. Published PCT application WO01/13082 (the disclosure of which is incorporated herein by reference) describes magnetised transducer elements for discs in which torque is transmitted between a central shaft to which the disc is mounted and the outer periphery of the disc. A gear wheel or a sprocket wheel is an example. The torque may be transmitted from a shaft to periphery or vice versa. The transducer element is an annulus of stored or remanent magnetisation circular about the shaft axis. The annulus comprises two concentric annular magnetic regions between which a torque-dependent magnetic field or field component is established dependent on the nature of the magnetisation employed. It is also possible to utilize a single region of annular stored magnetisation to provide such a field component. In the transducer elements described in WO01/13082 the magnetising source which created the stored magnetic region or regions is withdrawn after magnetisation and takes no part in the torque measurement process.

Another approach is disclosed in published PCT application WO 01/90711 published 29 Nov. 2001, the disclosure of which is incorporated herein by reference. This application discloses a disc transducer assembly for a continuously rotating disc in which a magnetic source, e.g. a permanent magnet, is maintained closely adjacent the disc to refresh the magnetisation of it on each revolution of the disc. Such an assembly may be employed without prior magnetisation of the disc, the magnetisation building up as the disc commences its rotation. A sensor arrangement is arranged at a point following the magnetising source in the direction of rotation. WO01/90711 also discloses the application of this refresh magnetisation technique to a spoked disc in which torque is transmitted between a central hub portion and an outer annular portion attached thereto by a structure having openings, such as a set of spokes that are relatively wide in the direction of rotation. More specifically the disc structure particular described is the chain wheel of a bicycle in which the cyclist generates a pulsating torque. In the embodiments described in WO01/90711, the magnetic source is mounted adjacent the spoked region of the disc such that it does not produce a complete annulus of magnetisation but rather a series of arcuate sections. As the chain wheel rotates the magnetic sensor arrangement generates a pulsed output.

In the chain wheel example, the rotation of a spoke past the sensor produces a single unipolar pulse which can be considered as equivalent to a single direct current pulse, which is the form of signal output by the sensor circuit. Thus in this context the detected magnetic pulse field can be considered as a D.C. field. Furthermore, in most cases it is the torque measured in a specific spoke which is of interest because of a desire to measure the peak torque generated by the pedalling action of the cyclist as the chain wheel rotates.

For the detection of the magnetic field, saturating-core inductor sensors may be employed as well as other sensor devices such as Hall effect and magnetoresistive devices. A particular sensor arrangement with which the present invention has been developed is the saturating-core inductor circuit described in WO98/52063. Two sensor devices can be connected into a single circuit in an additive or subtractive fashion. In the later description and drawings the abbreviation MFS may be adopted for brevity in referring to a magnetic field sensor.

A problem which can arise with magnetic-based torque sensing in discs, and particularly relatively thin discs, is that the magnetically active disc surface may be warped or may warp such as under the effects of torque or for any other reason, or the surface may not be mounted in an exactly radial plane. Warping of a disc may, for example, result from a mechanical deformation during a heat treatment process in its formation. Such warping can result in a modulation of the torque-representing output signal from the sensor arrangement as the disc rotates. Also the mounting of the disc may allow a degree of play or axial movement relative to the fixed sensor arrangement.

Another problem which may arise is in a procedure for demagnetising or magnetically cleansing the disc or relevant portion of it prior to magnetisation to form a transducer element in the disc. The pre-magnetisation procedure is important to obtaining consistent, uniform measurement as is discussed in WO01/13082 abovementioned. As the disc is larger so the demagnetisation equipment also becomes larger and is required to withstand larger magnetic stresses.

Yet another problem which has been found is that the torque-distribution in a disc may be non-uniform between what may be called the torque entry and torque exit points of the disc. Even with a solid disc, it has been found that a very thin disc does not evenly distribute the torque stress around the whole 360° of the sensing area. This leads to additional effort required in designing the torque transmission path and making the placement of the sensor arrangement rather critical to maintain signal stability as the disc rotates.

It is also the case that the mechanical torque stress upon which the detected magnetic field depends become smaller as the disc diameter increases. Consequently the output signal becomes smaller and the signal-to-noise ratio suffers.

Action taken to ameliorate one of the above problems may result in enhancing one of the others. In addressing the above problems, a new magnetisation technique has been developed which is considered to have wide and general utility in torque measurement.

### SUMMARY OF THE PRESENT INVENTION

The present invention provides a novel technique based on a concept which will be referred to as pulse-modulated magnetisation (PMM) which produces pulse-modulated torque-representing signals. The PMM may be applied in a unipolar form or as bipolar pulses of alternating polarity. As will become clear the sensing of the torque-dependent magnetic field component from the PMM produces an A.C. form of signal output. In this context the use of “A.C.” in connection with stored magnetic fields refers to fields of alternate polarity or producing an A.C. signal output. The PMM technique can also be applied to torque measurement in shafts such as disclosed in WO01/13081 and in published PCT application WO 01/79801 published 25 Oct. 2001, both of which are incorporated hereby by reference. The invention and its practice will be described below primarily in relation to disc structures as already discussed.

The practice of the invention will also be described with PMM in which the direction of the magnetisation about the axis of the disc is radial. Sensor techniques which are described for such magnetisation are also applicable where the magnetisation is a single uniform annulus of radial magnetisation.

Broadly stated in one aspect the invention provides a magnetic torque-sensing element comprising a disc through which torque is radially transmissible and a magnetised transducer region which is at least a section of an annulus about a torque axis to be responsive to the transmitted torque to emanate a torque-dependent magnetic field, wherein said transducer region is magnetised in a plurality of angularly offset segments.

In another aspect the invention provides a magnetic torque-sensing element comprising a member for transmitting torque about a torque axis in the direction of the axis, a transducer region in said member having a zone of axially-directed magnetisation extending about the torque axis, said zone being formed of angularly separated, axially-extending segments of magnetisation or of at least an arcuate section of an annulus of magnetisation and means associated therewith to define axially-extending, angularly offset segments of magnetisation.

A torque-sensing element in accordance with the invention may be incorporated in a transducer which also comprises one or more magnetic-field sensor devices responsive to a torque-dependent magnetic field or field component emanated by the transducer element.

A further aspect of the invention is concerned with a sensor arrangement for detecting a torque-sensitive radial magnetisation. To this end the invention also provides a transducer assembly comprising a magnetic-torque sensing element comprising a disc through which a torque is transmissible radially with respect to a torque axis, at least an arcuate section of an annulus of magnetisation about said torque axis, the magnetisation of said at least an arcuate section being radial, and two sensor devices for sensing the torque-dependent magnetic field emanated by said at least an arcuate section, wherein (a) the sensor devices have respective axes of response that are at an angle to the local magnetic field sensed thereby, and/or (b) the sensor devices have respective directions of response relative to the local magnetic field sensed thereby which are at an angle to one another.

The above aspect of the invention can be practised with the techniques of PMM set out above or with a continuously magnetised annulus or arcuate section of an annulus. Continuously magnetised is continuous in space, e.g. an annulus or section of an annulus having a uniform radial magnetisation of a given polarity.

Aspects and features of this invention are set out in the claims following this description.

The invention and its practice will be further described with reference to the accompanying drawings.

### BRIEF DESCRIPTION OF THE DRAWINGS

FIG. 1 diagrammatically illustrates the torque transmitted through a gear train to which the present invention may be applied;

FIG. 2 shows the face of a disc, e.g. a gear wheel in FIG. 1, which is encoded with a spatial pulse modulated magnetisation (PMM);

FIG. 3 illustrates one of ways in which the magnetisation can be applied;

FIG. 4 is a circuit for deriving a torque output signal with the aid of a reference PMM;

FIG. 5 shows an annular transducer region with radially-magnetised segments employing bipolar magnetisation;

FIG. 6 illustrates a perpendicular placement of a sensor device with respect to radial magnetisation presented in a linear representation;

FIGS. 7a-7c show sensed signal levels at zero torque and for respective opposite directions of varying torque for the sensor orientation of FIG. 6;

FIG. 8 is similar to FIG. 6 illustrating a sensor device aligned at an angle (obliquely) to the radial magnetic field;

FIGS. 9a-9c show sensed signal levels at zero torque and for respective opposite directions of varying torque for the sensor orientation of FIG. 8;

FIG. 10 is similar to FIG. 6 illustrating a sensor device oriented in-line with the radial magnetic field;

FIGS. 11a-11c show sensed signal levels at zero torque and for respective opposite directions of varying torque for the sensor orientation of FIG. 10;

FIG. 12 is a simplified block diagram for a sensor device such as shown in FIG. 6, 8 or 10 sensing the bipolar pairs of magnetised segments of FIG. 5 to obtain torque, speed and position outputs;

FIG. 13a is a diagrammatic representation of a transducer region for demonstrating the relation of signal output to the transducer region radius (TRR);

FIG. 13b shows the relationship of torque output and noise-to-signal ratio to TRR;

FIGS. 14a-14c illustrate a radial magnetised transducer region under conditions of zero torque and opposite directions of torque respectively, the representation here being of circular form;

FIG. 15a illustrates the angled placement of two sensors with respect to the radial magnetic field, the arcuate transducer region being represented in linear form;

FIG. 15b is similar to FIG. 15 showing the degree of alignment of the respective sensors with the magnetic field under torque, and one interconnection of the sensors for a differential response;

FIG. 16 is similar to FIG. 15a but is in a circular representation to show two sensors spaced and parallel to one another but at an angle with respect to the local magnetic field.

### DESCRIPTION OF EMBODIMENTS

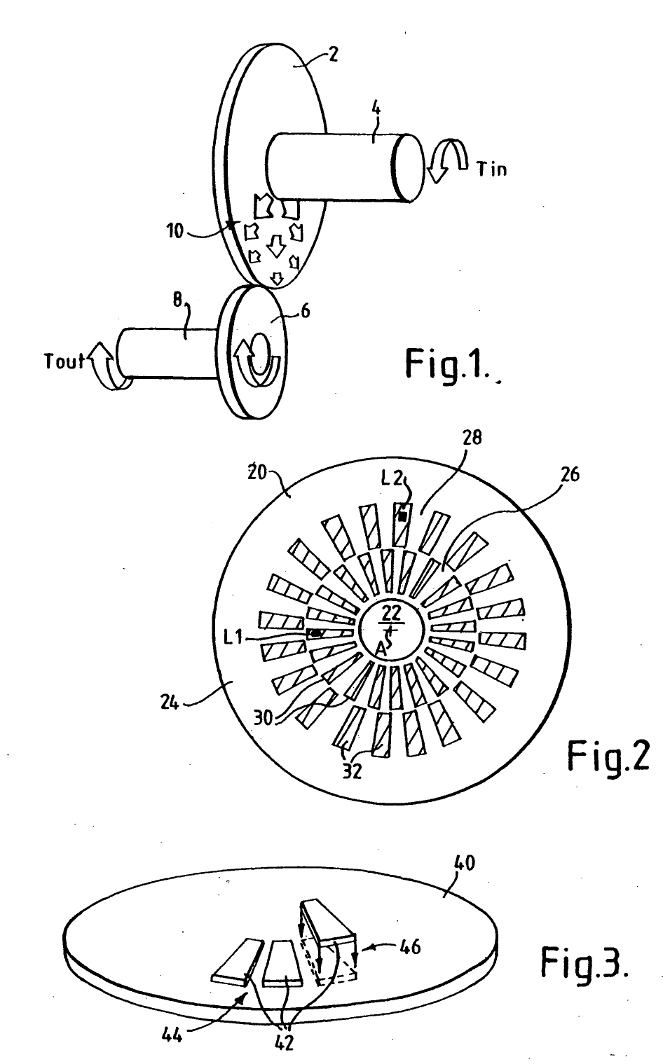

Referring to FIG. 1, there is shown a torque transmission system in which a gear wheel 2 mounted on a shaft 4 is driven about the axis of the shaft by an input torque Tin. Gear wheel 2 meshes with gear wheel 6 (for simplicity the teeth are not shown) which is mounted to shaft 8 to which a load (not shown) is connected for transmission of output torque Tout thereto. Gear wheel 2 is a disc structure and the radial arrows 10 indicate the direction of torque between the torque entry point from shaft 4 and the torque exit point where the gear wheels engage, The torque stresses in the gear wheel 2 decrease radially towards its periphery as indicated by the size of the arrows so that the stresses are much larger near the centre than at the periphery. It will be understood that the torque transmission could be in the opposite direction.

The objective is the measurement of the torque in the gear wheel 2. To this end the gear wheel is provided with pulse modulation magnetisation in accordance with the present invention. Referring now to FIG. 2, there is shown a face view of a circular disc 20, such as gear wheel 2, through which torque is transmitted between a central inner hub 22 and the outer periphery 24. The disc 20 is rotatable about central axis A and torque is transmitted between the central hub 22 of the disc and its outer periphery 24. Two annular regions 26 and 28 encircle the axis A and are magnetised in the manner to be described. The disc 20 is of ferromagnetic material to support the desired magnetisation. However the magnetisation could be applied to a disc of non-magnetisable material provided with magnetisable material as is discussed below. The provision of a torque-sensitive magnetisation that emanates a torque-dependent magnetic field is often referred to as encoding.

The magnetisation is applied in such a way that in each annulus 26 and 28 there are spaced segments of magnetisation such as 30 and 32 respectively, the spaces between the segments having little or no magnetisation. The segments have a uniform spacing—are periodic spatially, specifically angularly periodic,—about axis A to generate a regular periodic output signal in a sensor at constant rotational speed. By appropriate placement of a respective magnetic field sensor device (MFS) L1 and L2 adjacent but not in contact with the segments of annulus 26 and 28 respectively, it will be seen that the sensors are affected by a pulsed magnetic field and the sensor devices produce a pulsed output as disc 20 rotates. The spacing of the segments is related to the size of the sensors L1 and L2. Each sensor should resolve each magnetic segment to produce a pulsed output in accord with the passage of the segments past the sensor.

In FIG. 2, the inner ring of segments 26 is used for sensing torque. The outer ring 28 is not essential but has advantage in processing of the signal from MFS L1 to generate an accurate torque-representing signal. The MFS L2 can be used to generate a reference signal about which more is said below. By comparison with the disc 10 seen in FIG. 1, it will be understood that the inner magnetically encoded region 26 occupied by segments 30 is subject to higher torque stress than the outer magnetically encoded region 28 occupied by segments 32. As shown the segments 32 of the outer annulus 28 are offset by half the segment pitch (in angle) from segments 30 of annulus 26. This is not essential, the segments 30 and 32 could be radially aligned but the offset assists in preventing interaction in the sensing of the segments. A radial separation between the annular rings 26 and 28 is desirable. The segments may be radially magnetised. In the example being considered, the segments 30 are all of the same polarity as are the segments 32 but the polarity of segments 32 does not have to be the same as that of segments 30. As an alternative the segments could be magnetised in the direction of the disc axis A, that is normal to the plane of disc to have opposite polarity at the two disc surfaces or at the respective major surfaces of the segments where the disc is non-magnetic.

The segments 30 or 32 need not form a complete annulus. They may be applied in arcuate sections each having a plurality of segments. For example, if the disc 20 was an open structure with spokes such as the chain wheel above-mentioned, a spoke would have a plurality of segments to produce a train of pulses as the spoke passes the MFS and the pulse output would be interrupted trains of pulses. A section of an annulus rather than a complete annulus may also be appropriate in cases where the disc 20 only undergoes a limited range of angular movement.

The magnetisation or encoding of the disc 20 to provide each annulus of magnetic segments can be done in a number of ways. The magnetisation procedure requires a magnetic source such as a permanent magnet assembly or an electromagnet. One way is to rotate the disc (of ferromagnetic material or carrying an annulus of such material) with respect to a magnetic source (usually it is easier to rotate the disc relative to a fixed source) in such a manner as to directly imprint the PMM. This may be easier done with an electromagnet which can be rapidly switched on and off. The magnetic source is oriented to produce a radial field. The ferromagnetic material is a relatively hard magnetic material that is remanently (permanently) magnetised so as to retain or store the magnetism. Preferably the applied magnetising field magnetises the magnetic material to saturation

An alternative to pulsing the magnetic source with respect to a uniform annulus of material is to provide the annulus with a spatially periodic series of indents or protuberances so as to modulate the emanated field. The indents may extend to being apertures through the disc 10. The emanated field may not go to zero between the segments provided by the indents, protuberances or whatever. Another approach is illustrated in FIG. 3 in which a disc 40 has magnetised segments 42 applied to one face. For clarity of illustration just an arcuate section 44 is shown as so treated. This technique may be used with non-magnetisable discs such as aluminium or plastic. For example, a magnetisable material such as nickel or a nickel alloy can be formed on the disc surface by deposition or plating. Nickel can be plated on aluminium by a galvanizing-type of process but requires the aluminium surface to be cleaned of oxide first. Selective deposition or plating can be employed or deposition/plating followed by selective etching. An alternative is to bond pre-formed segments of a foil or magnetic material to the disc surface as is diagrammatically illustrated at 46 for one exemplary segment.

The magnetisations considered so far are unipolar producing what has been referred to above as D.C. magnetisation. Bipolar magnetisation can be employed as is described further below.

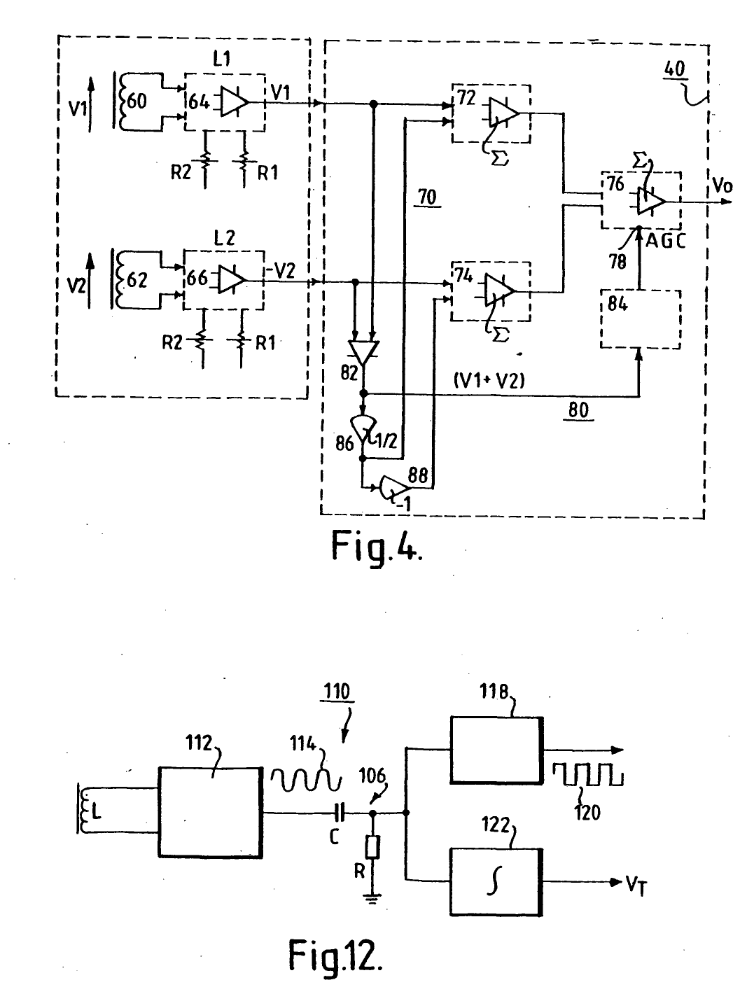

Considering the use of the two annuli 26 and 28 of FIG. 2, the segments 30 together with sensor L1 and the segments 32 together with sensor L2 form respective transducer assemblies that are connected into appropriate detection circuits. As will become clear, the segments of annulus 26 provide a torque-representing signal while the less torque-sensitive segments of annulus 28 provide a reference signal. FIG. 4 shows one form of circuit to produce a torque-representing output signal from the respective signals produced by sensors L1 and L2 of the saturating-core inductor type. The sensors L1 and L2 may each comprise plural MFS devices connected into a common detector circuit. In FIG. 4 the respective saturating core inductor(s) of L1 and L2 is denoted 60 and 62 respectively. Each inductor is connected in a circuit of the kind shown in WO98/58032 above-mentioned to produce a respective signal denoted V1 and V2 in FIG. 4. The circuit of FIG. 4 is based on that disclosed in WO00/57150. A sensor L1 or L2 may comprise say two saturating core inductors that are located and connected in series such that they co-operate additively as regards the torque-dependent magnetic field but are in opposition as regards a common mode field such as the Earth's magnetic field. Plural MFS devices may also be deployed at locations around an annulus for averaging purposes.

Referring to FIG. 4, it shows an analogue processing circuit 40 for processing the signals derived from sensors L1 and L2 which are illustrated as the single coil sensors 60 and 62 respectively connected into a respective driver and control circuit and buffer amplifier all generally denoted as 64 and 66 respectively. Each of the buffer amplifiers of circuits 64 and 66 has associated with it a means R2 for adjusting the amplifier gain, assumed to be nominally unity, and a means R1 for adjusting the amplifier offset. The relative polarities of sensor voltages V1 and V2 depend on their orientation with respect to the segments 30 and 32 and the directions of magnetisation applied in the two annuli 26 and 28. The two sensors L1 and L2 are illustrated in the circuit of FIG. 4 to have the voltages V₁ and V₂ induced in the same sense and to have any signal due to the earth's magnetic field or other extraneous field induced in the same sense. Thus each of V₁ and V₂ is in practice the resultant of the torque dependent magnetic flux sensed thereby and any extraneous unwanted flux.

In one of the sensor signal processing circuits, L2, say, the input signal is inverted so that the respective buffer amplifiers produce output signals V₁ and −V₂ for further processing. The circuit 40 comprises a main signal path 70 and an automatic gain control loop 80. The circuit is designed to combine the signals V₁ and V₂ to provide an output voltage Vₒ

Vₒ=V₁−V₂.

In the main signal path 70, the voltages V₁ and −V₂ are applied to inputs of respective summing amplifiers 72 and 74 of equal (unity) gain. Each amplifier has a second input receiving a signal whose derivation is described below. The output of amplifiers 72 and 74 are applied as inputs to an output summing amplifier 76 to provide the output Vₒ. Amplifier 76 is a gain controlled amplifier having an input 78 for receiving a gain control signal from the gain control path 80.

The automatic gain control (AGC) loop includes a difference amplifier 82 to which the voltages V₁ and −V₂ are applied to thereby obtain a reference signal (V₁+V₂). This reference signal is applied through block 84 to develop a signal at appropriate level to control the gain of summing amplifier 76 in accord with an initialising procedure discussed further below. The action of this forward gain control loop is further described below.

The output of difference amplifier 82 is divided-by-2 at 86 and the output is passed directly to a second input of amplifier 72 and via an inverter 88 to a second input of amplifier 74 to re-enter the main signal path.

The operation of the circuit 40 is as follows.

The signals applied to the two inputs of amplifier 72 are V1 and a signal derived from the summation of V₁ and V₂ in the AGC loop 80. The signals applied to the two inputs of amplifier 74 are −V₂ and the same second signal as applied to amplifier 72, but inverted. The signals applied to the inputs of amplifier 76 from amplifiers 72 and 74 are summed subject to a gain control to provide an output

Vₒ=k(V₁−V₂),

where k is a gain factors

It is worth noting here that the sensor devices 60 and 62 were so arranged that any induced signal components, such as from the earth's magnetic field were in the same sense with respect to V₁ and V₂ so that these components will be cancelled from the final output.

It will be understood that the compensation techniques discussed above could be implemented in software. For example, the sensor output signals V₁ and V₂ may be digitised and the functions of the signal processing circuit 40 including the AGC action implemented on the digitised signals using software routines.

The circuit described above was disclosed in WO00/57150 for D.C. signals V1 and V2. It will be appreciated that where V1 and V2 are pulsed signals, the circuit will have to be adapted accordingly by using smoothing, integrating or averaging techniques, applied in analogue or digital fashion.

Also in the transducer region configuration of the disc of FIG. 2, the torque-dependent signal level from the outer annulus 26 may be expected to be less than that from the inner annulus 28. The signal from MFS L1 is the primary torque signal. It may, however, be affected by factors such as warp, overall variation of the axial spacing between the sensors and the disc surface, or degradation in the strength of magnetisation. The outer annulus provides a reference signal also affected by these same factors against which the wanted torque output signal can be obtained.

The concept of pulse modulation magnetisation can also be applied to longitudinal annular magnetisations—that is having the magnetisation in an axial direction—in a shaft or the like. In particular the surface-adjacent annulus of magnetisation can be created in the shaft and the surface be treated in a way that modifies the emanated field as a function of angle about the shaft axis. Forms of longitudinal magnetisation are disclosed in WO00/13081 and WO 01/79801, both of which are referred to above.

In the embodiments discussed above, where the PMM is created in or by means attached to the disc or shaft, it is of course, necessary that the form of attachment ensures that the torque in the disc or shaft is accurately reflected in the torque in the attached means.

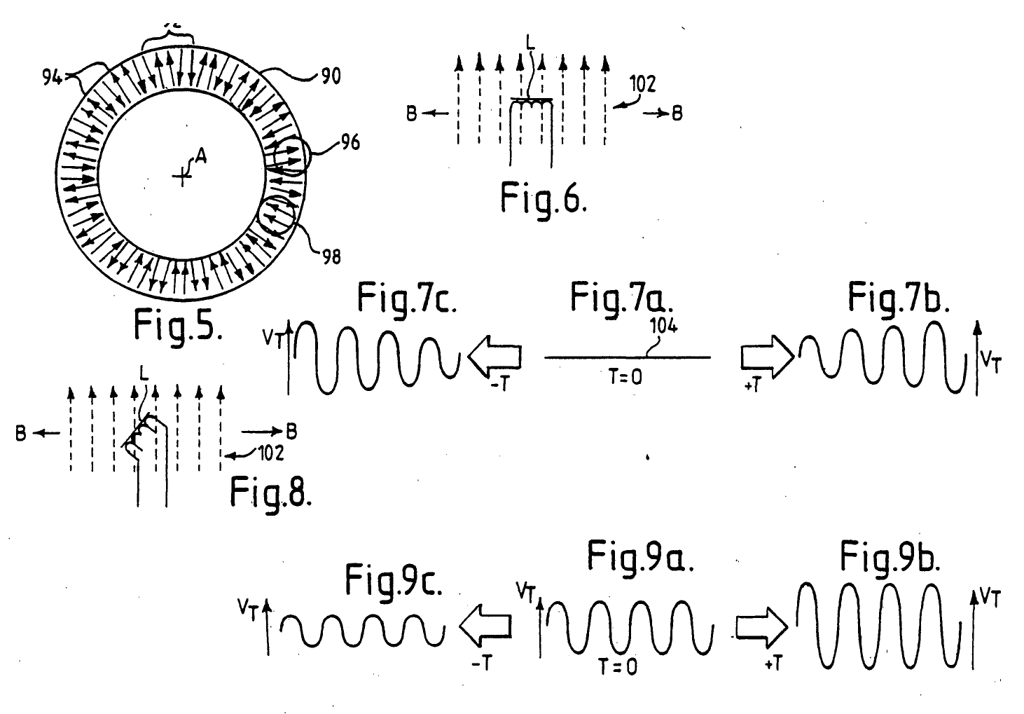

Attention will now be given to encoding a transducer region with an annulus of bipolar magnetisation of alternating polarity at a regular spatial periodicity. An example of this is shown in FIG. 5 which shows a circular, magnetically-encoded, annular transducer region 90 rotatable with a disc (not shown) about axis A. As described above it is assumed that the disc has torque transmitted radially through it to create a radially directed torque stress in region 90. The region 90 comprises segments such as 92 of one radial polarity alternating with segments such as 94 of the opposite radial polarity about axis A. These segments of alternate polarity can be created by switching an electromagnet. For clarity of illustration the magnetisation of each segment is indicated by two arrows. An MFS placed as indicated by circle 96 or 98 will respond to just one segment. It will be understood that the magnetisation of the transducer region 90 is shown in a diagrammatic manner. As the region rotates about axis A a sensor which is located at position 96 or 98 generates a true A.C. output signal. By using a pair of sensors responsive to segments of opposite polarity, these can be connected and placed such that torque-dependent field components add but a common D.C. component such as an extraneous field like the earth's magnetic field is cancelled. As noted above, in a circuit such as that described in WO98/52063, the two saturating-core inductor sensors can be connected in series in the same sensing circuit.

The annulus 90 of FIG. 4 can be continuously magnetised (in a spatial sense) about its axis with next adjacent segments of opposite polarity. The segments could be provided as discrete entities separated from one another as in FIG. 2. The transducer region 90 can also be supplemented by an outer annulus of segments—unipolar or bipolar—to provide a reference as described above.

Other aspects of MFS performance will now be considered with particular reference to saturating-core inductor devices or coils as they may be referred to for brevity. A coil will be denoted in general terms by the symbol L. As in FIG. 5, the supporting disc structure for the annular magnetised region is not shown.

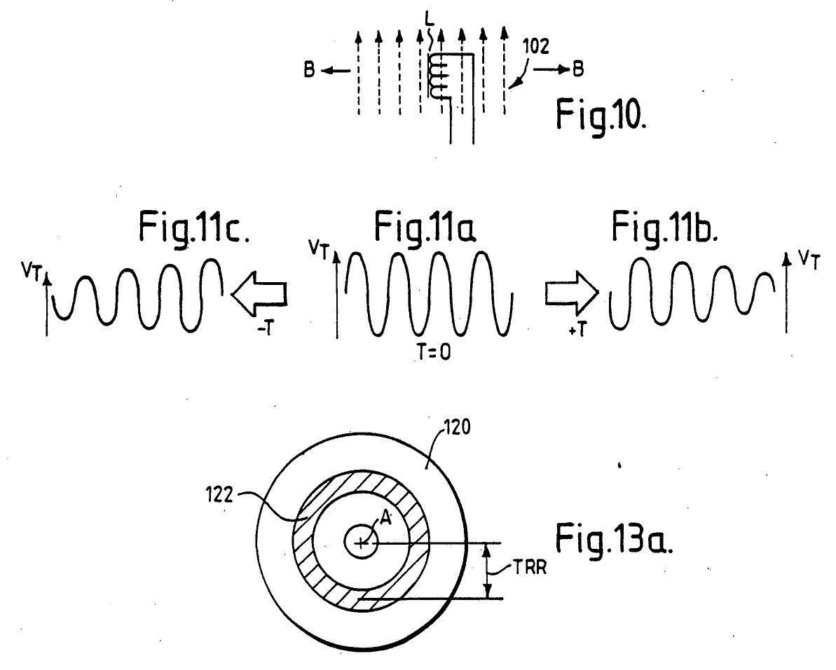

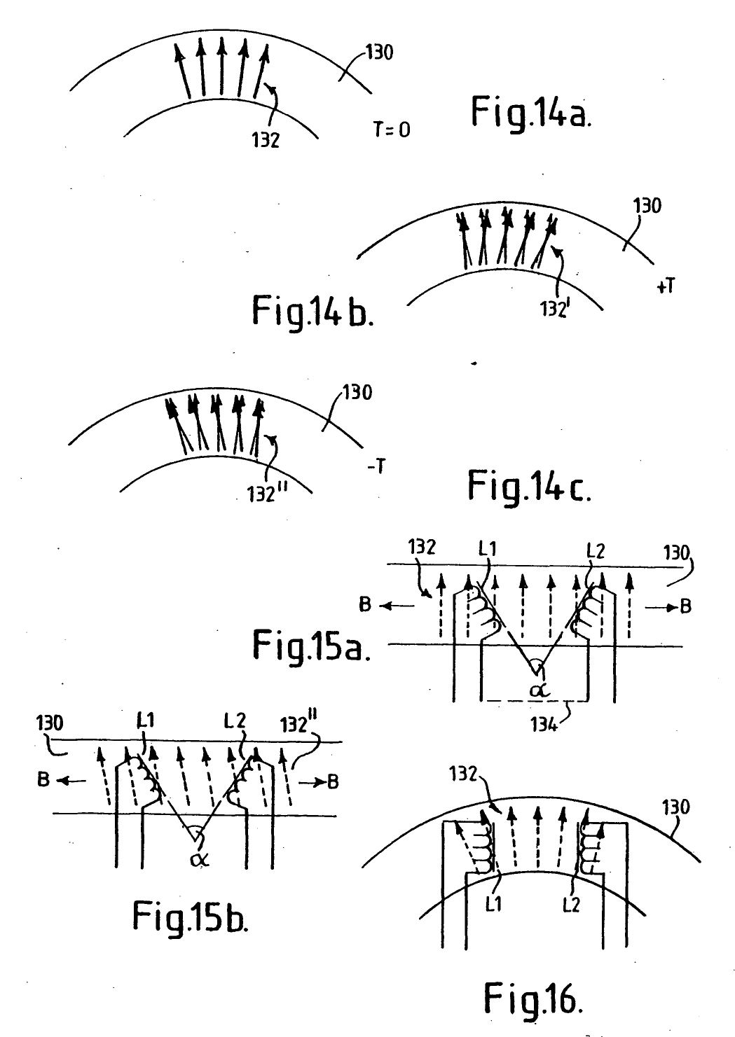

The placement of the sensor coil or coils relative to a radial magnetic field will now be considered with reference to FIG. 6. For ease of illustration, an arcuate segment 100 to which a sensor coil L responds is shown in a linear representation so that the radial stored magnetic field is denoted by parallel arrows 102. The rotation of the arcuate segment becomes movement of the magnetisation 102 along axis B-B. The segment 100 may, for example, be a segment 92 or 94 shown in FIG. 5 and the examples given below are for a bipolar magnetisation encoding as shown in FIG. 5. FIG. 6 shows the MFS L placed perpendicularly to the radial field, i.e. parallel to the axis B-B. The MFS has a resolution that is less than or at least not greater than the width of the segment being sensed. The effect of torque on the segment is to offset the direction of the magnetic vector from the radial direction by an extent dependent on the magnitude of the torque stress and resultant strain. Diagrammatic illustrations of the field deflected by torque are seen in FIGS. 14a-14c and FIG. 15 described below. That is under torque the magnetic vector will be deflected at an angle in one direction or the other dependent on the polarity of the applied torque (clockwise or counter-clockwise). For the purposes of the next following discussion the two directions of torque will be referred to as negative and positive. Three orientations of a sensor device with respect to the magnetic field being sensed will be discussed. These are perpendicular (FIG. 6), angled (FIG. 8) and aligned or in-line (FIG. 10). A saturating-core inductor type of sensor has an axis of maximum sensitivity along the axis of the coil and a null in a plane normal to that axis. In FIGS. 6, 8 and 10, for clarity of illustration, the magnetic field in region 100 represented by field arrows 102 is shown as normal to a linear axis B-B (rather than the radial field normal to an arcuate axis in FIG. 5) and the field is moving relative to the coil sensor L in the direction of axis B-B. This is equivalent to the rotation of the transducer region 90 about axis A in FIG. 5

FIGS. 7a to 7c illustrate signal outputs V_{T} representing torque for three torque conditions. FIG. 7a relates to a zero-torque condition and FIGS. 7b and 7c relate to positive and negative torque conditions as indicated by the respective broad arrows (+T and −T). They further relate to increasing values of torque where the axis of the waveform of FIGS. 7b and 7c (in angle and time) is in the direction of the associated broad arrows.

Referring to FIG. 6 the MFS L is perpendicular to the field lines 102 as the field moves past the MFS in the direction of axis B-B under conditions of no torque. There is no output from the sensor as is shown by the zero value line 104 in FIG. 7a. The output will remain at zero as opposite polarity segments of region 90 in FIG. 5 are detected by MFS L. As the magnetic field deflects from the perpendicular to axis B-B as a result of torque, an output signal V_{T} is generated which, for a bipolar field as is illustrated in FIG. 5, will be a bipolar or A.C. output signal. This is seen in both FIGS. 7b and 7c which further illustrate the signal V_{T} increasing as an increasing torque is applied in region 100 in a positive and negative direction respectively. In practice where the applied torque is changing, it is expected that there will be several cycles of the output signal V_{T} of essentially the same amplitude at any particular torque level.

The output signal V_{T} may be of a pulsed form—unipolar or bipolar pulsed—rather than sinusoidal form. Referring again to FIG. 5, where a pair of sensor coils are employed to detect the field from segments of opposite polarity so that individually they would produce output signals180° out of phase, the two devices can be connected in reverse series to add their respective A.C. field components. Such a connection of two devices into one circuit is possible in a signal conditioning and processing circuit such as is described in WO98/52063 mentioned above. Depending on placement of the two devices with respect to region 90 in FIG. 5 a reverse series connection not only provides for an additive (summing) connection of the desired A.C. field components but allows a common external D.C. field component, e.g. the Earth's magnetic field, to be cancelled from the output signal to the extent that the sensors are aligned with the external field component.

FIG. 8 is similar to FIG. 6, but shows the sensor L placed at an angle, say 45°, to the field 102 and thus to the radial field of region 90 in FIG. 5. Consequently at zero torque as the transducer region 90 of FIG. 5 rotates the sensor L is sensitive to a zero-torque component as seen in the resultant output signal V_{T} in FIG. 9a. At a constant applied positive torque—which deflects the field arrows to be more in line with the sensor axis—the torque-dependent output signal amplitude increases as shown in FIG. 9b. Conversely at constant negative torque bringing the field arrows 102 nearer perpendicular with the sensor axis the torque-dependent output signal decreases as shown in FIG. 9c.

FIG. 10 shows the case where the sensor axis is in line with the zero-torque field with maximum output as shown in FIG. 11a. FIGS. 11b and 11c show the torque-dependent output for decreasing positive and negative torques respectively.

One feature of the torque sensing so far described and which emerges from FIGS. 6-11c is that, the amplitude of the torque-dependent output V_{T} is independent of the speed of rotation of the region 90 in FIG. 5 or the transducer arrangement of FIG. 2. For a given torque and subject to the frequency response of the electronics, a constant amplitude output signal will be obtained as the speed of rotation decreases, and the pulse or A.C. signal output frequency likewise decreases, down to zero speed and frequency. The latter case is detection of torque in a stationary torque or shaft or any part subject to torque. The actual pulse rate practically measurable depends on the response of the electronics. The saturating core sensor is capable of high response speeds. Detection at rotational speeds of zero to 40 krpm can be contemplated.

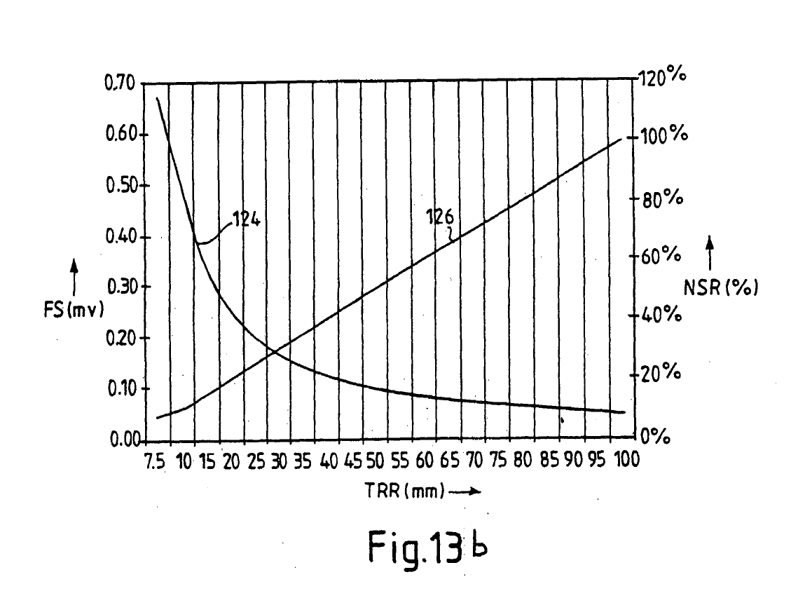

Returning to the subject of signal processing using the PMM technique of the present invention, FIG. 12 shows a block diagram of a simplified detection and processing circuit 110. The MFS inductor L is connected in a circuit 112 of the kind discussed earlier—such as disclosed in WO98/52063—that produces the A.C. output 114. This may be pulses or other periodic waveforms rather than near sine waves. The output 114 may contain a D.C. component due to a stray-field not otherwise cancelled out or other slower fluctuations on which the wanted signal is superimposed. The signal 114 is applied to a high-pass filter (HPF) 116—represented by a CR circuit—to eliminate the D.C. component and low frequency fluctuations. The signal may be applied to a Schmidt trigger 118 or like shaping circuit to sharpen up the waveform into pulses 120 for counting as a measure of rotational speed or for cumulatively counting as a measure of angular position. The signal 114 is also applied to a detector/integrator 122 which, if necessary, rectifies the bipolar A.C. signal, and integrates the result using an appropriate time-constant to obtain a torque-representing output signal V_{T}.

The characteristics selected for the HPF 116 are related to the number of magnetic signal pulses per revolution of the disc and the expected rotational speed of the disc between minimum and maximum rpm, and the expected rates of change of disturbance or strong magnetic fields. For a minimum rpm of 60 (i.e. one disc rotation per second) an annular transducer region should have preferably at least 40 segments or 40 bipolar pairs of segments for a reasonably straightforward specification of the HPF design. If the minimum rate of rotation were say 600 rpm then the number of segments may be reduced but regard may need to be paid to the maximum rate of rotation which affects the high frequency response of the electronics. For example a 6000 rpm disc with 40 bipolar pairs of segments will generate a 2 kHz output signal which the electronics has to be capable of handling.

Mention has already been made of the decrease in the signal output as the annulus of magnetised segments is located away from the disc centre. This applies equally to a continuous annulus. The property is shown in FIGS. 13a and 13b. FIG. 13a illustrates a disc 120 of 2 mm thickness having a transducer region 122, taken to be a single annulus, radially magnetised as a continuous annulus, and positioned at a given radius TRR (transducer region radius) which is the radius from the disc centre A to the centre of the transducer region. FIG. 13b shows a plot 124 of output signal amplitude at a given maximum allowed torque referred to as full-scale (FS) as a function of TRR and also a plot 126 of noise-to-signal ratio (NSR) (in contrast to the conventional SNR) which climbs to unusable levels as the TRR increases.

The compensation for factors such as warp and axial movement which affect torque measurement has so far been described in terms of a transducer region having two concentric annuli of spaced segments, or arcuate sections of such segments. The inner one is preferably used to develop the primary torque measurement signal, the outer to provide a reference signal. As previously discussed if no compensation is to be effected a single annulus of segments may be employed.

There will now be described a torque transducer assembly having a transducer region, such as region 122 in FIG. 13a, which uses a single annulus of magnetisation with two sensor devices at an angle to one another to provide the output signal by a technique which may be referred to as differential signal measurement (DSM).

Referring to FIGS. 14a-14c, they show a part of an annular transducer region 130 which is radially magnetised as a continuous annulus as shown by arrows 132. FIG. 14a shows the arrows directed radially at zero torque. FIGS. 14b and 14c show the arrows deflected at 132′ and 132″ in opposite directions for opposite directions of torque about the axis (not shown) of the annulus. This is in accord with what has already been described with reference to FIGS. 6, 8 and 10 in which the annulus and its radial magnetisation were shown in a linear representation. These figures showed the placement of a sensor L in a transverse (perpendicular), angled and in-line (radial) orientation respectively.

FIG. 15a shows a representation of the magnetisation 132 of annulus 130 in a linear representation at zero torque. There are two sensors L1 and L2 in angled orientation with respect to the field lines 132, the sensors being angled in opposite senses. Sensors L1 and L2 have the sensing axes of their respective saturating cores at an angle a to one another with respect to the radial field, though not necessarily at a physical angle to one another as will become clear below. If the two sensors are at equal angles to the flux arrows, i.e. α/2, then by connecting the two in reverse series in a circuit such as shown in WO98/52063, and as indicated by the chain line connection 134, then a zero output will be obtained. The result may be expressed as

L1+L2=0,

where L1 and L2 here indicate the signal contributions from the two inductors. FIG. 15b shows the situation where the annulus 130 is under torque deflecting the magnet field arrows in one direction as indicated at 132b (see FIG. 14c). The field aligns more with L1 and less with L2 so that the difference signal is no longer zero but at a value representing the applied torque, i.e.

L1+L2=torque signal.

It is to be noted that if the signals from L1 and L2 are separately derived, they can be differentially combined as described and also they can be additively combined. In particular, the sum of the absolute values of the signals is a measure of the signal gain in the transducer arrangement, i.e. the gain attached to the transfer function, so that the difference value can be modified in accordance with the gain value. In the terms already used,

Abs(L1)+Abs(L2)=Signal Gain.

In the linear representations of arcuate sections such as in FIGS. 15a and 15b, the angle a is not necessarily the actual physical angle between the sensor devices L1 and L2. FIG. 16 corresponds to FIG. 15a but transformed back to a circular form. The sensors L1 and L2 are parallel but form an angle to one another with respect to the local directions of the radial field.

The techniques described above can be applied to torque sensing in a continuous annulus of radial magnetisation. It is not restricted to PMM. Where it is applied with PMM, it will be understood that the spacing of L1 and L2 around the annulus has to be chosen with regard to the segment spacing (angular period). If L1 and L2 are both located at the same segment or at like polarity segments, a different interconnection is required as compared with L1 and L2 being located at opposite polarity segments. It is again assumed that L1 and L2 will each resolve a single segment or less.

1. A magnetic torque-sensing element comprising a disc through which torque is radially transmissible and a magnetised transducer region which is at least a section of an annulus about a torque axis to be responsive to the transmitted torque to emanate a torque-dependent magnetic field, wherein said transducer region is magnetised in a plurality of angularly offset segments.

2. A magnetic torque-sensing element as claimed in claim 1 in which said segments are magnetised in the radial direction and adjacent segments are angularly separated.

3. A magnetic torque-sensing element as claimed in claim 2 in which said at least one section of an annulus is completely radially magnetised and means are provided to define said segments.

4. A magnetic torque-sensing element as claimed in claim 1 in which said segments are magnetised in the axial direction and adjacent segments are angularly separated.

5. A magnetic torque-sensing element as claimed in claim 1 in which said segments are magnetised in the radial direction, adjacent segments being magnetised in opposite directions.

6. A magnetic torque-sensing element as claimed in claim 1 in which said segments are magnetised in the axial direction, adjacent segments being magnetised in opposite directions.

7. A magnetic torque-sensing element as claimed in claim 1, wherein the magnetised transducer region comprises a further plurality of magnetised segments arranged in at least a section of an annulus radially outwardly of the first-mentioned annulus.

8. A magnetic torque-sensing element as claimed claim 1, wherein the or each annulus (or section thereof) is circular about the torque axis.

9. A transducer assembly for sensing torque comprising an element as claimed in claim 1, having at least one sensor device mounted adjacent the or each annulus (or section thereof), the or each sensor device and the segments being relatively dimensioned that the or each sensor device is capable of resolving the torque-dependent magnetic field emanated by a single segment.

10. A transducer assembly as claimed in claim 7 in which said disc is mounted for rotation about said torque axis.

11. A transducer assembly as claimed in claim 7, wherein the response axis of the or each sensor device is radial, or transverse to the radial direction, preferably perpendicular, or oblique to the radial direction.

12. A magnetic torque-sensing element comprising a member for transmitting torque about a torque axis in the direction of the axis, a transducer region in said member having a zone of axially-directed magnetisation extending about the torque axis, said zone being formed of angularly separated, axially-extending segments of magnetisation or of at least an arcuate section of an annulus of magnetisation and means associated therewith to define axially-extending, angularly offset segments of magnetisation.

13. A transducer assembly for sensing torque comprising an element as claimed in claim 12 having at least one sensor device responsive to the magnetic field emanated by said transducer region.

14. A transducer assembly as claimed in claim 13 in which the or each sensor device and said segments are relatively dimensioned that the sensor device is capable of resolving the torque-dependent field emanated by a single segment.

15. A transducer assembly as claimed in claim 12, wherein said member is a shaft mounted for rotation about said torque axis.

16. A transducer element or assembly as claimed in claim 12, wherein said zone is circular about the torque axis.

17. A transducer assembly comprising a magnetic-torque sensing element comprising a disc through which a torque is transmissible radially with respect to a torque axis, at least an arcuate section of an annulus of magnetisation about said torque axis, the magnetisation of said at least an arcuate section being radial, and two sensor devices for sensing the torque-dependent magnetic field emanated by said at least an arcuate section, wherein
(a) the sensor devices have respective axes of response that are at an angle to the local magnetic field sensed thereby, and/or
(b) the sensor devices have respective directions of response relative to the local magnetic field sensed thereby which are at an angle to one another.

18. A transducer assembly as claimed in claim 17 in which said at least an arcuate section of an annulus is magnetised in discrete angularly spaced segments of magnetisation or is continuously magnetised and provided with means defining angularly spaced segments for the emanation of the torque dependent magnetic field.

19. A transducer assembly as claimed in claim 17 in which said at least an arcuate section of an annulus is magnetised in segments of magnetisation of alternate polarity.

20. A transducer assembly as claimed in claim 17 in which said at least an arcuate section of an annulus is continuously magnetised.
